(19) United States
(12) Patent Application Publication
(10) Pub. No.: US 2004/0073326 A1
(43) Pub. Date: Apr. 15, 2004

(54) Method and system for managing engineer-modified trial operation

(76) Inventors: Weng-Chang Chang, Taipei (TW); Wen-Cheng Chang, Taipei (TW); Chien-Ming Tseng, Taipei (TW); Chih-Chen Chen, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/384,088

(22) Filed: Mar. 7, 2003

(30) Foreign Application Priority Data
Oct. 15, 2002 (TW) 91123658

(51) Int. Cl. G06F 19/00

(52) U.S. Cl. 700/106

(57) ABSTRACT

A method and a system for managing engineer-modified trial operation are provided, for use in an enterprise to perform automatic integration planning for engineer-modified related processes. By computer information management technology and network technology, an online trial operation procedure is executed for a confirmed engineer-modified project. This procedure involves material planning and uploading trial data to a quality control department after the trial is completed to produce a trial operation test report that is directed to associated departments. Compared to the prior art, the integration planning conducted by the proposed system allows employees of the enterprise to more easily access and manage data in real time, thereby improving operational efficiency of the enterprise.

### FIELD OF THE INVENTION

The present invention relates to methods and systems for managing engineer-modified trial operation, and more particularly, to a method and a system for managing engineer-modified trial operation by which an enterprise can perform automatic integration planning for engineer-modified related processes via a computer network system to enhance operational efficiency thereof.

### BACKGROUND OF THE INVENTION

With advance in science and technology, as well as wide application of technologies in electronics, information, and automation, a huge step is gained for developing production technology. As the market gets more and more competitive, the whole society is driven by such competition to move forwards rapidly, creating a harsh environment for an industry to survive. For the manufacturing business, the industry needs to develop within the shortest time a product that satisfies the market demand without spending too much capital. As the market demand continues to change, the demand for better structure and function of the product gets higher. So, engineers have to constantly enhance the throughput and quality of the product in the competitive market. An engineer-modified project is usually submitted to improve the working efficiency and product quality in the manufacturing process. While an engineer-modified proposal becomes the engineer-modified project after the examination, it is subjected to a trial operation procedure (also known as test procedure).

Conventionally, the material planning department submits manually the material list required for the test by paper. And together with the process list submitted by the quality control department according to the test procedure, both the material list and process list are transmitted manually to the corresponding production lines. After the production line conducts the test according to the process planned by the quality control department, the test result data is manually transmitted to the quality control department. Then, the quality control department produces the trial operation report from the test result data before sending the report to the material planning department, production line department, engineer-modified invoice department, and other relative departments to determine whether to adopt the engineer-modified proposal.

Since all the forms are filled and transmitted manually in the conventional method, not only are time and cost increased for conducting the manual verification, but the expected due date is not met as the progress of the manual verification is not kept track of at verification stage for each department. This leads to a reduced efficiency in the working process. And as each stage of the conventional manual verification process is unable to make a synchronized change with other stages or departments for the engineer-modified invoice managing process at the trial operation stage, inconvenience in tracking the error is caused.

### SUMMARY OF THE INVENTION

In light of the problems associated with the conventional art, an objective of the present invention is to provide a method and a system for managing engineer-modified trial operation, so as to enhance the engineer-modified operation efficiency.

Another objective of the present invention is to provide a method and a system for managing engineer-modified trial operation, so as to keep track of an operation progress.

A further objective of the present invention is to provide a method and a system for managing engineer-modified trial operation, whereby the engineer-modified invoice managing process at the trial operation stage can be changed synchronously with other stages or departments.

As embodied and broadly described herein, the invention provides a system for managing engineer-modified trial operation, and the system is installed in a network server linked to a network system, such that a user can makes an online entry via the network system using a terminal device. The system comprises of a database for storing engineer-modified project data and material related data input from outside; a material form producing module for searching a material list and corresponding part number in the database according to the engineer-modified project data, and outputting the material list and corresponding part number to the terminal device of the material planning department, so that employees from the material planning department can find the desired material quickly; a process planning module for forming a trial operation process with the operation from the user, and transmitting the trail operation process to the terminal device of the production line, so that the employees of the production line can operate according to the trial operation process; and a test report producing module for producing a test report form from test result data input by the user, and the test report form is transmitted to the terminal device of the related department online.

According to another objective described above, the present invention further comprises of an expiry date regulating module that enables to user to input an operation expiry date, so that an informing message is issued to inform the user of the terminal device when the operation date is expired.

The invention also provides a method for managing engineer-modified trial operation, which method is achieved by using the system for managing engineer-modified trial operation and the system is installed in the network server linked to the network system, such that the user can make the online entry via the network system using the terminal device. The method comprises steps of establishing a database to receive the engineer-modified project data and material related data input from outside; commanding a material form producing module to search a corresponding part number according to the desired material input from the engineer-modified project data in the database, and the part number forms a trial operation process to be output to the terminal device of material planning department, so that the employees from the material planning department can find the desired material quickly and send to the production line; commanding a process flow planning module to output a trial operation process according to an operation from the user, and to transmit via the network system to the terminal device of the production line, so that the employees of the production line can operation according to the trial operation process; and commanding a test report producing module to produce a test report form according to a test result data after the test is complete, and output the test report form to the terminal device of the related department for a final assessment.

By comparison to the conventional art, operation procedures for material part number list and planning trial operation can be quickly established online with the method of managing engineer-modified trial operation and system for the same according to the present invention, so as to reduce time and money wasted on manual operation. And by informing the employees from the production line of the expiry date using the expiry date regulating module, problems regarding to regulation of the expiry date caused by human errors are also reduced. With this system, the process of the trial operation is made more logic, without creating a random process.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram illustrating a basic setup of a system for managing engineer-modified trial operation according to one preferred embodiment of the present invention; and

FIG. 2 is a flow chart illustrating a method of managing engineer-modified trial operation according to the present invention.

### DETAILED DESCRIPTION OF THE PREFERRED EMBODIMENTS

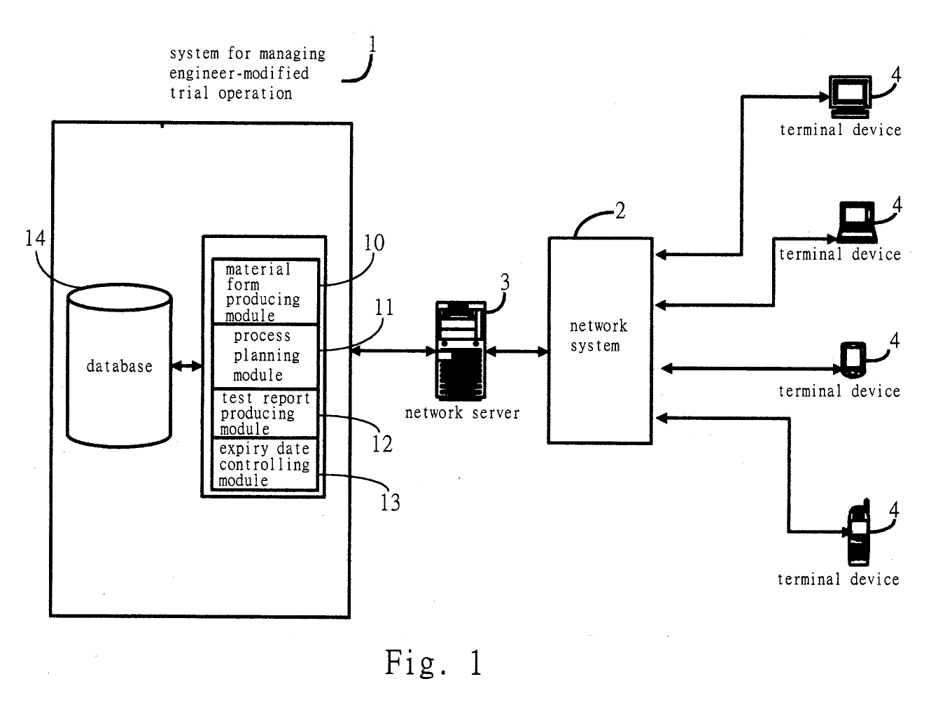

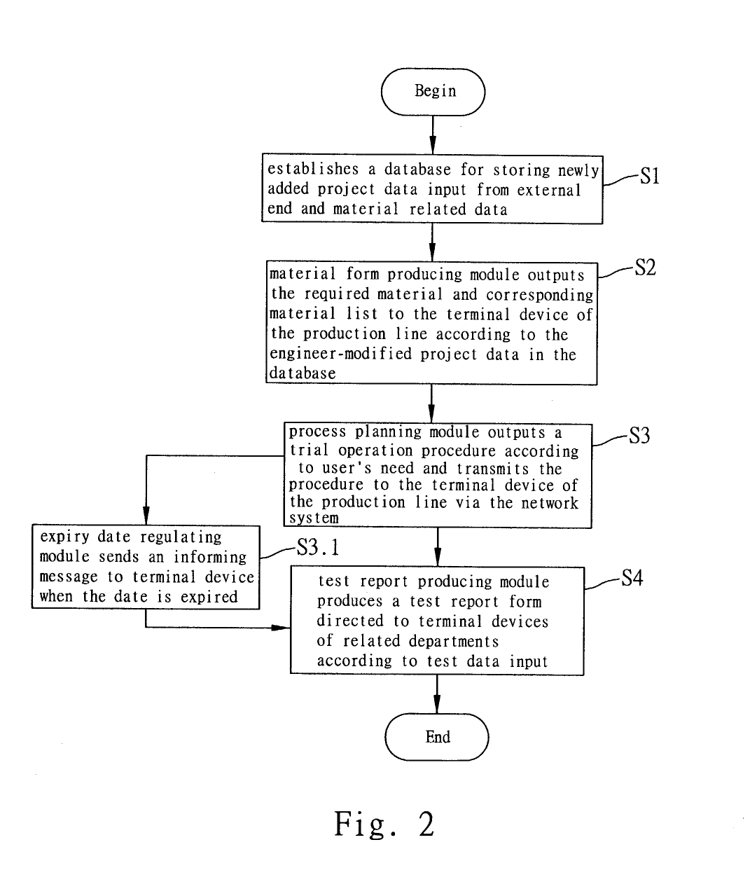

A method and a system for managing engineer-modified trial operation proposed in the present invention are described in detail with reference to FIGS. 1 and 2 below.

As shown in FIG. 1, the system for managing engineer-modified trial operation 1 is installed in a network server 3 that is linked to a network system 2, so that the user can make an online entry via the network system 2 (either Internet or Intranet) using a terminal device, such as desktop computer, notebook computer, mobile phone, or personal digital assistant (PDA). The system for managing engineer-modified trial operation 1 comprises a database 14, a material form producing module 10, a process planning module 11, and a test report producing module 12.

The database 14 stores the engineer-modified project data and material related data, including data such as material name, corresponding material code, and so on input from outside (for example, an engineer-modified project producing module).

The material form producing module 10 enables the user of the material planning department to search the material list and corresponding part number in the database 14 according to the material required for the engineer-modified project data. The material list and corresponding part number are then output to the terminal device of the material planning department, so that the employees from the material planning department can find the required material quickly.

The process planning module 11 enables the employees from the quality control (QC) department to input the process required for the engineer-modified project using the terminal device 4. And the completed process is then transmitted via the network system 2 to the terminal device 4 of the production line.

The test report producing module 12 enables the employees from the production line to input the result data of the trial operation in the network system 2 using the terminal device 4. The test report form is then output to terminal devices 4 of the related departments (such as QC department, material planning department, and engineer-modified invoice department) to be examined by the employees of the departments.

FIG. 2 is a flow chart illustrating a method for managing engineer-modified trial operation according to the present invention.

First of all, step S1 is executed by establishing a database for storing the newly added project data and storage material related data input from outside (for example, engineer-modified project producing system).

Next, step S2 is executed, where a material form producing module is commanded to search according to the engineer-modified project data for the required material and corresponding part number, including data such as material name, corresponding material code, and so on. Then, a material list is produced and transmitted to the terminal device of the production line department online.

In step S3, a process planning module is commanded to output an operation process according to the operation from the user (such as employees from the QC department). And the completed process is output via the network system to the terminal device of the production line.

In step S4, the production line conducts a trial operation (also known as a test operation) according to the operation process, and a plurality set of test result data is produced after the test is done. The test result data is input to a test report producing module, which produces a test report form including the results is output to the terminal devices of the related departments (such as QC department, material planning department, and engineer-modified invoice department) online as reference and assessment.

It is worth noted that the step S3 further comprising a sub-step S3.1 for regulating the expiry date. The expiry date regulating module is set with an operation expiry date (for example, 5 days). So, when the set working date is expired, the expiry date regulating module issues an informing message to the terminal device of the production line, so as to remind the operation date is expired.

Summarizing from the above, a method of managing the engineer-modified trial operation and the system for the same are provided, whereby a computer network information technology is adopted to integrate operation processes and electronic data from different departments. As a result, operation procedures for material part number list and planing trial operation can be quickly established online, so as to reduce time and money wasted on manual operation in the conventional art. And by informing the employees from the production line of the expiry date using the expiry date regulating module, problems in regulating the expiry date caused by human errors are also reduced. With this system, the process of the trial operation is also made more logic, without creating a random process.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A system for managing engineer-modified trial operation, established in a network server linked to a network system, for allowing a user to log in the system for managing engineer-modified trial operation via the network system through the use of a terminal device, the system for managing engineer-modified trial operation comprising:
a database for storing externally input engineer-modified project data and material related data;
a material form producing module for searching a list of materials and corresponding part numbers thereof from the database according to the engineer-modified project data, and forwarding the searched data of materials and part numbers thereof to a terminal device of a material planning department by which desirable materials are quickly obtained;
a process planning module for forming a trial operation process according to the user's operation, and transmitting via the network system the trial operation process to a terminal device of a production line where the trial operation process is performed; and
a test report producing module for receiving test result data input by the user and accordingly producing a test report form which is transmitted to a terminal device of an associated department.

2. The system of claim 1, wherein the network system is Internet.

3. The system of claim 1, wherein the network system is an intranet.

4. The system of claim 1, wherein the terminal device is selected from the group consisting of desktop computer, portable computer, personal digital assistant (PDA), and mobile phone.

5. The system of claim 1, wherein the terminal device uses an Internet browser for browsing online data.

6. The system of claim 1, further comprising an expiry date regulating module for allowing the user to input an operational expiry date, and issuing an informing message to the terminal device of the user when the operational expiry date is reached.

7. A method for managing engineer-modified trial operation, for use with a system for managing engineer-modified trial operation, for allowing a user to log in the system for managing engineer-modified trial operation via the network system through the use of a terminal device, the method comprising the steps of:
establishing a database for receiving externally input engineer-modified project data and material related data;
having a material form producing module search a list of materials and corresponding part numbers thereof from the database according to the engineer-modified project data, and forward the searched data of materials and part numbers thereof to a terminal device of a material planning department by which desirable materials are quickly obtained;
having a process planning module form a trial operation process according to the user's operation, and transmit via the network system the trial operation process to a terminal device of a production line where the trial operation process is performed; and
upon completing the trial operation process, having a test report producing module receive test result data input by the user and accordingly produce a test report form which is transmitted to a terminal device of an associated department for a final assessment.

8. The method of claim 7, wherein the network system is Internet.

9. The method of claim 7, wherein the network system is an intranet.

10. The method of claim 7, wherein the terminal device is selected from the group consisting of desktop computer, portable computer, personal digital assistant (PDA), and mobile phone.

11. The method of claim 6, wherein the step of performing the trial operation process further comprises an expiry date regulating step by which an expiry date regulating module is set with an operational expiry date and issues an informing message to the terminal device of the user when the operation expiry date is reached.
